(19) United States
(12) Patent Application Publication
(10) Pub. No.: US 2002/0106259 A1
(43) Pub. Date: Aug. 8, 2002

(54) Reinforced plastic bolt with injection molded head and mold therefor

(76) Inventor: Stephen R. Kaufman, Georgetown, TX (US)

Correspondence Address: CHRISTOPHER J. ROURK, AKIN, GUMP, STRAUSS, HAUER & FELD, L.L.P., P O BOX 688, DALLAS, TX, 75313-0688, US

(21) Appl. No.: 09/777,206

(22) Filed: Feb. 5, 2001

(51) Int. Cl. F16B 23/00

(52) U.S. Cl. 411/396

(57) ABSTRACT

A nonmetallic threaded fastener, such as a machine screw or bolt, is formed by injection molding a plastic head over one end of a continuously threaded shank, preferably formed of glass fiber reinforced plastic. The fastener is formed in a three part mold including a first part threadedly connected to the shank and received in a bore in a second part of the mold. The second mold part is joined to a third part which includes a cavity for receiving molten plastic to form the fastener head integrally molded to one end of the continuously threaded shank part.

### FIELD OF THE INVENTION

The present invention pertains to a threaded machine bolt or screw having a hex head or a manually graspable knob type head and a mold for making the bolt by injection molding the head over a preformed reinforced plastic threaded shank.

### BACKGROUND OF THE INVENTION

In the art of threaded fasteners, particularly, threaded machine bolts and the like, there are many applications where a nonmetallic bolt or bolt and nut assembly are advantageous or necessary. For example, in equipment used in certain chemical process industries it is desirable to provide machinery and other structures which use nonmetallic fasteners to minimize fastener failures and the inability to disassemble such structures as a consequence of fastener corrosion. In certain other industries, such as industries which require equipment and structures for electromagnetic radiation testing or control it is desirable to provide nonmetallic fasteners for fastening machines and other structures to avoid adverse affects of metal fasteners in the radiation testing and control processes.

Reinforced plastic externally threaded members, sometimes known as all-thread members, are known. Moreover, plastic and molded threaded machine screws and nuts are all also known in the art. Attempts have been made to utilize high-strength reinforced plastic threaded shank or all-thread members suitably adhesivably secured to a threaded plastic nut to form a threaded plastic bolt. However, these efforts have been unsuccessful. Accordingly, there has been a continuing need to develop a high strength machine screw or bolt having a reinforced plastic threaded shank and a bolt head which may be securely fastened to the threaded shank in a manner which will result in a structure serving as a high strength screw or bolt and which will not result in failure due to separation or turning of the head with respect to the shank. It is to these ends that the present invention has been developed.

### BRIEF SUMMARY OF THE INVENTION

The present invention provides an improved reinforced plastic threaded fastener, including, in particular, a threaded machine screw, bolt, or the like having a reinforced plastic threaded shank and a plastic head suitably secured to the shank in a way which will not result in failure of the bolt due to turning of the head with respect to the shank.

In accordance with one important aspect of the invention a nonmetallic threaded fastener is provided in the form of a machine bolt and the like including a head which may be engaged by a wrench to tighten the bolt or including a manually graspable knob type head which may be used in applications where the bolt may be tightened or loosened manually, at will. In particular, the nonmetallic screw or bolt of the invention is formed with a reinforced plastic shank, such as a glass fiber reinforced externally threaded member having continuous threads thereon from one end to the other, otherwise known as an all-thread member.

The present invention also provides a nonmetallic fastener having a shank portion formed by a fiber reinforced plastic threaded rod of a predetermined diameter and length to which a plastic bolt head is permanently attached adjacent one end of the shank by an injection molding process. In a preferred embodiment, the shank or rod is a continuous externally threaded glass fiber reinforced plastic rod and the bolt head is formed of an injection molded thermoplastic, such as a reinforced or unreinforced ABS plastic. The bolt head may also be formed of materials such as fiber reinforced or unreinforced Nylon 6/6 or polypropylene. A one piece nonmetallic fastener is formed which is of approximately twice the tensile strength of a conventional nonmetallic fastener formed of unreinforced ABS plastic, for example.

In accordance with yet another aspect of the invention a multi-part mold is provided for supporting a threaded shank or rod part of a nonmetallic fastener in the form of a machine bolt having a hex head or a manually graspable knob type head, for example.

Still further, the present invention contemplates an apparatus and process for forming a nonmetallic fastener comprising a glass fiber reinforced plastic shank or rod which is continuously threaded and to which is injection molded a plastic head to provide a superior high strength nonmetallic fastener.

Those skilled in the art will further appreciate the above-mentioned advantages and superior features of the invention together with other important aspects thereof upon reading the detailed description which follows in conjunction with the drawing.

### BRIEF DESCRIPTION OF THE SEVERAL VIEWS OF THE DRAWINGS

FIG. 1 is an end view of an acorn head machine bolt in accordance with the present invention;

FIG. 2 is a longitudinal side elevation of the bolt shown in FIG. 1, partially sectioned;

FIG. 3 is a longitudinal central section view of a mold for forming the bolt shown in FIGS. 1 and 2;

FIG. 4 is an end view of an alternate embodiment of a machine bolt in accordance with the present invention;

FIG. 5 is a longitudinal side elevation, partially sectioned, of the bolt shown in FIG. 4;

FIG. 6 is a view taken from the line 6-6 of FIG. 7 showing a part of a mold for forming the head of the bolt shown in FIGS. 4 and 5;

FIG. 7 is a longitudinal central section view of a mold for making the bolt shown in FIGS. 4 and 5;

FIG. 8 is a schematic diagram of a molding apparatus for use with the molds shown in FIGS. 3 and 7; and

FIG. 9 is a flow diagram in accordance with a preferred method of forming the bolt of the present invention.

### DETAILED DESCRIPTION OF THE INVENTION

In the description which follows like parts are marked throughout the specification and drawing with the same reference numerals, respectively. The drawing figures are not necessarily to scale and certain features may be shown in somewhat schematic or generalized form in the interest of clarity and conciseness.

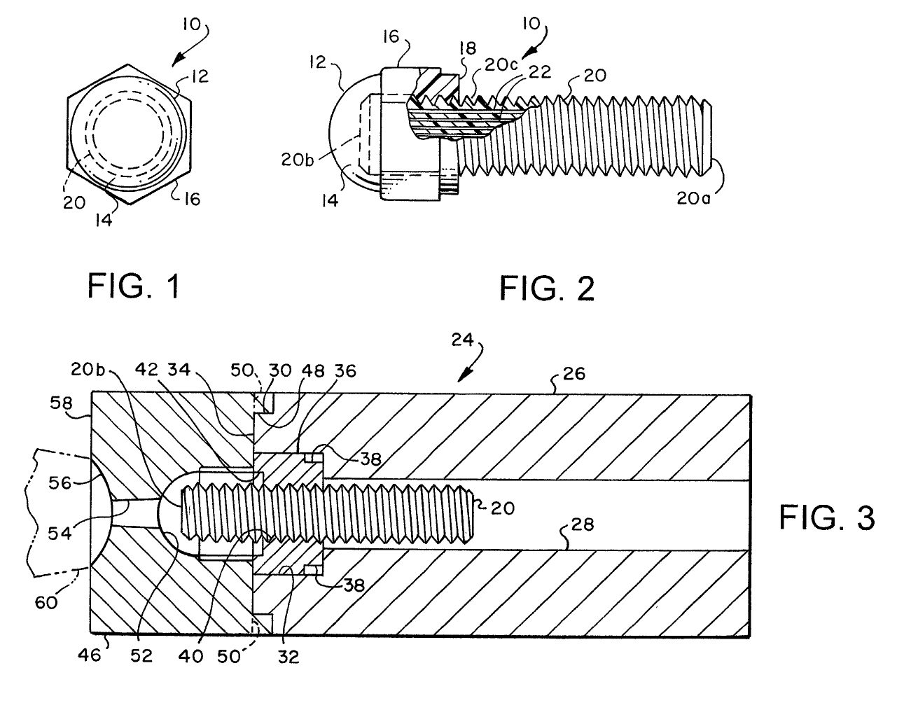

Referring to FIGS. 1 and 2, an improved nonmetallic machine screw or bolt in accordance with the invention is illustrated and generally designated by the numeral 10. The bolt 10 includes a conventional, so-called acorn hex head 12 having a somewhat hemispherical head part 14 and a hexagonal, wrench engageable, head part 16. The bolt head 12 may be formed in accordance with the geometry of and U.S. or SAE standard dimensions for machine screws and alike. The bolt head 12 also includes a reduced diameter integral washer face or collar 18, FIG. 2, opposite the head part 14.

As shown in FIG. 2, the head 12 is connected to an elongated externally threaded shank part 20, one end of which is embedded in and over molded by the head 12. The threaded shank 20 may be formed with conventional standard machine screw threads 20c of selected dimensions and geometries in accordance with specific applications of a machine screw or bolt, such as the bolt 10. The shank 20 is threaded throughout its length from its distal end 20a to the opposite end 20b which is encapsulated by the overmolded head 12. The shank 20 is preferably formed of a reinforced plastic and one embodiment of the bolt 10 includes a shank formed of glass fiber reinforced plastic having plural longitudinally oriented glass fibers 22 extending substantially the length of the shank 20 and embedded in a resin to form a so-called fiberglass shank or rod which is threaded throughout its length and is typically referred to in the art as an all-thread. Accordingly, the shank 20 is preferably formed of a reinforced plastic such as a glass fiber reinforced polyester material. However, those skilled in the art will recognize that the reinforced plastic shank 20 may include other types of fiber reinforcements and may utilize other resins encapsulating such fiber reinforcements. Moreover, the head 12 is also preferably formed of a molded plastic material, such as ABS, Nylon 6/6 or polypropylene polymers, any of which may be reinforced by encapsulated fibers, if desired.

It has been discovered in accordance with the present invention that an ABS plastic, Nylon 66 or polypropylene plastic head, such as the head 12, may be formed by injection molding over the shank 20 and having a head configuration in accordance with standard engineering requirements and using an injection molding process generally known to those skilled in the art. Such a bolt may be constructed which is of superior strength and provides a head for a machine bolt which will not fail by turning relative to the shank as with heads which are secured by chemical adhesives by “gluing” a conventional hex or acorn nut to one end of an all thread shank part, such as the shank 20. In other words, by injection overmolding the head 12 and similar bolt head configurations a superior high strength nonmetallic fastener is provided.

Referring now to FIG. 3, there is illustrated in longitudinal central section a preferred embodiment of a mold 24 for molding the bolt 10 and similar nonmetallic threaded fasteners and the like. The mold 24 includes a first mold apart 26 comprising generally cylindrical body member having an elongated central bore 28 formed therein and being of a diameter slightly greater than the diameter of a shank part of a machine bolt, such as the shank 20 for the bolt 10 shown disposed in the mold 24. Mold part 26 includes a generally cylindrical integral locating collar or flange 30 at one end thereof and an enlarged diameter counterbore 32 coaxial with the bore 28 and the flange 30 and opening to an endface 34 of the mold part 26.

A second mold part 36 is shown disposed in the bore 32 and comprises a generally cylindrical member having opposed wrench flats 38 formed thereon and adapted for engagement with a conventional open or adjustable wrench, not shown. Mold part 36 is internally threaded with threads 40 of the same geometry as the threads 20a of shank 20 and is operable to support the shank 20 in the bore 28, as illustrated. The mold part 36 is generally cylindrical and is a snug sliding fit in the bore 32 and, when disposed in the bore 32, is substantially flush with the endface 34. Mold part 36 includes a coaxial counterbore 42 operable to form the integral cylindrical washer face 18 of the bolt head 12.

The mold 24 includes a third mold part 46 comprising a generally cylindrical member having a counterbore 48 formed therein for receiving collar or flange 30 to locate the mold part 26 with regard to the mold part 46 when the mold is assembled. Opposed vent slots 50 are preferably formed on the mold part 46 and intersect the bore 48 for venting air from a mold cavity 52 formed in the mold part 46 and coaxial with the bore 48. Mold cavity 52 conforms to the geometry of the head 12 in cooperation with the mold part 36. An injection port 54 is formed in the mold part 46 and intersects the cavity 52 and a recess 56 formed in an endface 58 for registration with an injection nozzle 60 of an injection molding machine, not shown in FIG. 3.

Accordingly, the mold 24, comprising the mold parts 26, 36 and 46 may be assembled, as illustrated in FIG. 3, with a shank 20 supported therein by the mold part 36. The mold parts 26 and 46 may be clamped in a suitable injection molding machine of a type known in the art and molten plastic injection carried out to form the bolt 12 head by injecting molten plastic into the cavity 52 to encapsulate the end 20b of the shank 20. Thanks to the mold part 36, the shank 20 is suitably supported in the mold 24 and, upon withdrawal of the bolt 10 from the mold 24, the mold part 36 may be unthreaded from the shank 20. Of course, the hex head part 16 of the now finished bolt 10 may be grasped by a wrench as well as the mold part 36, if substantial forces are required to unthread the mold part 36 from the shank 20 after completion of formation of the bolt 10.

Injection molding of the head 12 to the shank 20 provides a superior high strength nonmetallic machine screw or bolt in accordance with the invention. The configuration of the head 12 may be one of several so called standard bolt heads or any specialized head required by the application of the screw or bolt. ABS plastic, reinforced or unreinforced, provides a superior injection molding material for molding the head 12 of the bolt 10. The end 20b of shank 20 is positioned within the cavity 52 in such a way that a substantially constant cross sectional thickness of the head 12 is formed which facilitates strong injection molded parts without risking distortion of the head due to the shrinking of extra thick portions of the plastic material during the molding process. As previously mentioned, other materials may be injection molded to form the head 12, including Nylon 6/6 or polypropylene, for example.

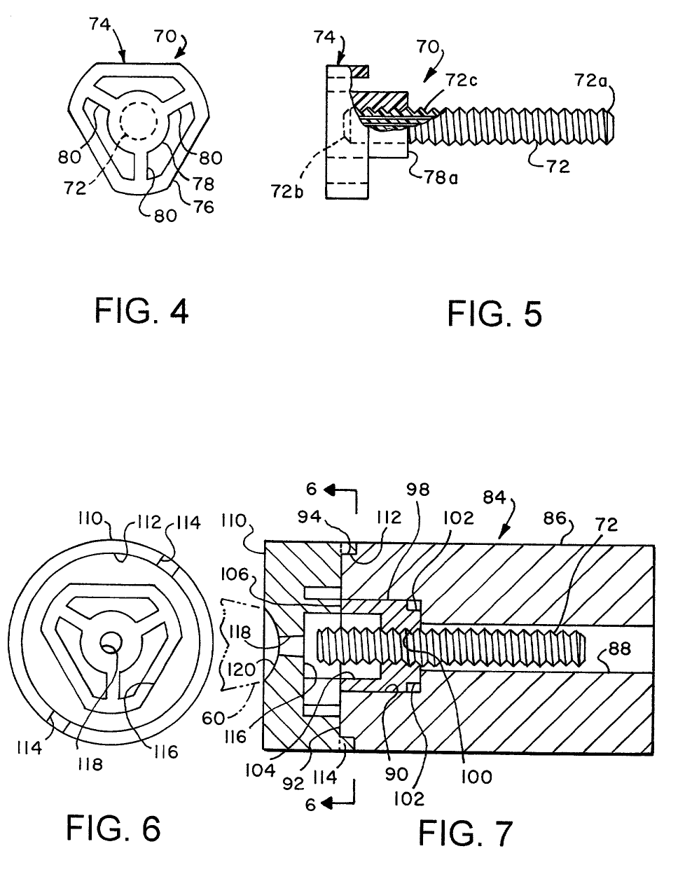

As previously mentioned, substantially nonmetallic machine screws, bolts or similar threaded fasteners may be formed in accordance with the invention, as illustrated by way of example in FIGS. 4 and 5. Referring to FIGS. 4 and 5 another embodiment of a machine screw or bolt in accordance with the invention is illustrated and generally designated by the numeral 70. Machine bolt 70 includes a threaded shank 72 similar to the shank 20 and also preferably formed of glass fiber reinforced plastic and configured with external threads 72c of conventional machine screw thread geometry. The shank 72 has a distal end 72a and an opposite end 72b which is overmolded by an injection molded manually graspable knob shaped head 74. Head 74 includes a somewhat triangular rim part 76 of substantially constant cross sectional thickness and which is attached to a substantially constant cross sectional thickness hub part 78 by three integral circumferentially spaced apart spokes 80. The spokes 80 are each also of about the same cross sectional thickness as the rim 76 and the hub 78. As shown in FIG. 3, the hub 78 is approximately twice the length of the rim 76 and includes an end face 78a engageable with structure, not shown, when the bolt 70 is threadedly engaged with such structure, or with a conventional non-metal or metal machine nut, also not shown.

As with the bolt 10, the bolt 70 is preferably formed in the same manner and of the same materials, namely, the shank 72 is preferably a reinforced plastic member of continuous threads 72c in the same manner that the shank 20 has continuous threads 20c. The shank 72 is overmolded by an injection molded head 74 which is preferably formed of reinforced or unreinforced ABS plastic, Nylon 6/6 or polypropylene.

Referring now to FIGS. 6 and 7, there is illustrated a mold for forming the machine bolt 70, and generally designated by the numeral 84. The mold 84 includes a first mold part 86 which may be cylindrical or non-cylindrical, as with the mold part 26, but having a generally cylindrical through bore 88 formed therein and of a diameter sufficient to receive the shank 72 of the bolt 70 with at least a small amount of clearance, so that the shank may be easily inserted in or removed from the bore 88, again as with the relationship between the shank 20 and the bore 28 of mold part 26. Mold part 86 includes a cylindrical counterbore 90 coaxial with the bore 88 and opening to an endface 92 formed on a reduced diameter pilot locating flange or collar 94 of mold part 86.

Mold 84 includes a second mold part 98 comprising a generally cylindrical plug member having internal threads 100 which correspond to the external threads 72c formed on the shank 72. Opposed wrench flats 102 are formed on one end of the mold part 98, as shown. Mold part 98 is a snug sliding fit in the bore 90 and includes a counterbore 104 opening to an end face 106 opposite the end of the mold part which includes the wrench flats 102. Counterbore 104 is coaxial with the internal threads 100.

Mold 84 includes a third mold part 110 including a bore 112 adapted for receiving the locating flange or collar 94 of mold part 86 for aligning the mold parts 86 and 110 with each other in the assembled position, as shown. Opposed gas vent slots 114 may be formed in mold part 110 and opening to bore 112 to vent gas from a mold cavity 116 which is configured to form the head 74, see FIG. 6 also. As shown in FIG. 7, mold part 110 also includes a central axial injection port 118 opening to the cavity 116 and to a recess 120 for receiving injection head or nozzle 60 for the injection of molten plastic into the cavity 116 to form the head 74.

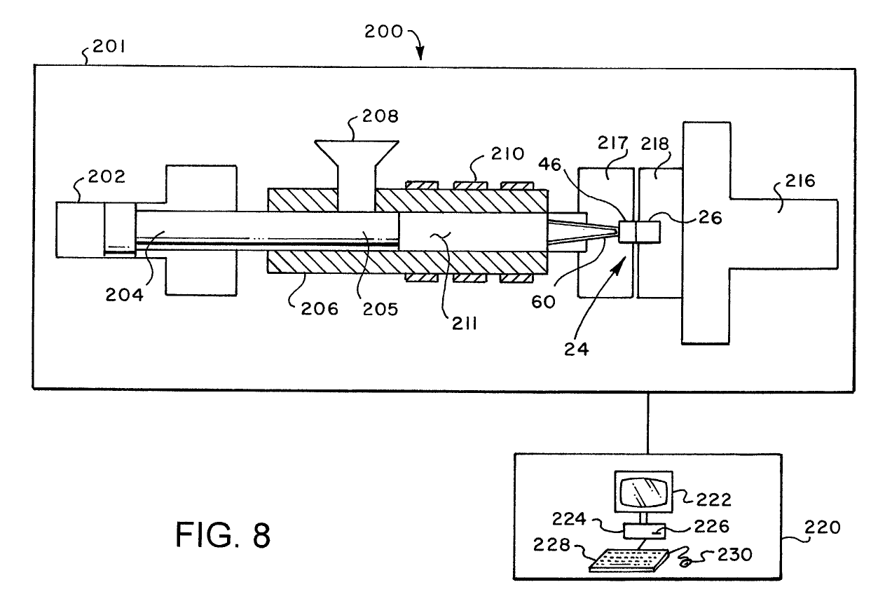

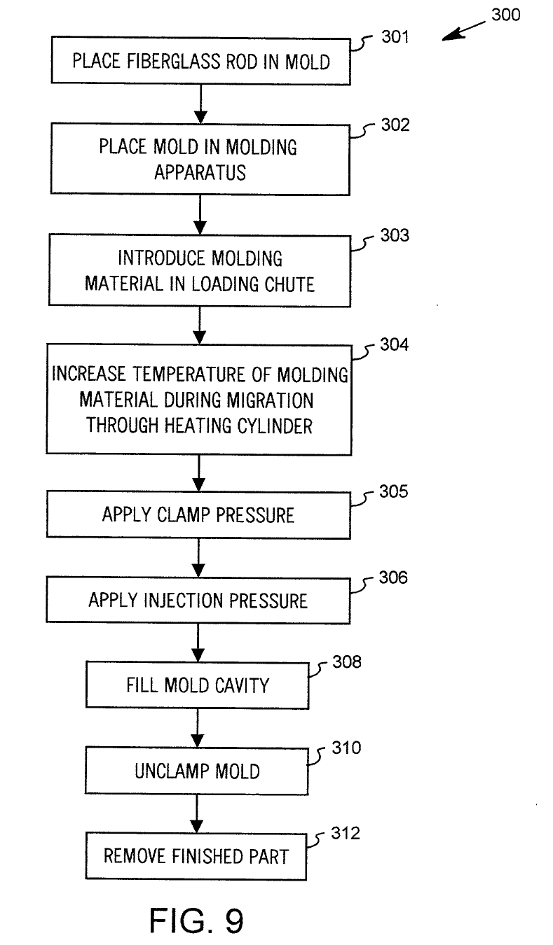

A process of molding either of the bolts 10 or 70 will now be described in conjunction with FIGS. 8 and 9. Referring to FIG. 8, an apparatus for forming various injection molded threaded fasteners in accordance with the invention is illustrated in somewhat schematic form and comprising a system 200 including an apparatus 201 coupled to a control system 220. The system 200 includes an injection source 204 that is partially encased in a heating cylinder or barrel 206. A material loading chute 208 is in communication with the heating cylinder 206 which also supports a suitable heat source 210. In one embodiment the heat source may be an electric resistance pad assembly, for example. The heated mold injection source 204 includes a plunger or piston or may comprise a screw type plunger, for example. Injection source 204 is operably connected to a hydraulic cylinder 202 to advance a piston or plunger 205 toward the opposite end of the apparatus. Pumpable molding material may reside in chamber 211 and be operable to be discharged through nozzle 60 which fits partially into molds 24 or 84, as previously described. Mold 24 is shown by way of example and may be supported by opposed separable support members 217 and 218 and a clamp mechanism 216 which provides a clamping pressure against the force exerted by way of the injection source 204.

The control system 220 may comprise one or more input devices including a computer 224, a monitor 222, a keyboard 228, a mouse type controller 230 and one or more storage devices 226. Storage devices 226 may include one or any combination of floppy disk drives, hard disk drives, CD-ROM drives, tape drives, etc. Computer 224 typically includes a processor and memory, such as any combination of read-only memory or random access memory. The computer 224 employs an application program that receives and executes each molded part “recipe” to control the molding system 200. The “recipe” may comprise a set of instructions in the form of a program or the like so that one or more molded part “recipes” may be created and stored in storage device 226.

FIG. 9 is a flow chart illustrating an exemplary molding process “recipe” for injection molding a head to a threaded shank in accordance with the embodiments of the fastener described and shown hereinbefore. The fiberglass shank 20, for example, is threadedly engaged with mold part 36 and placed in the bore 28, 32 in mold part 26 in accordance with the steps of block 301 and with at least part of the end 20b of the shank disposed in cavity 52 of mold part 56. The mold 24 is then placed in the molding system 200, as shown in block 302 of FIG. 9.

Molding material, as previously described, preferably includes a thermoplastic such as an ABS type plastic. Suitable ABS plastic pellets are introduced into the loading chute 208, FIG. 8, and pass through the heating cylinder 206 of the injection source 204, as indicated in block 303 of FIG. 9. The control system 220 then instructs the heating source 210 to raise the temperature of the heating cylinder 206, as indicated in block 304 of FIG. 9. At a sufficient melting temperature, the plastic pellets previously described become somewhat fluid-like and allow being pushed forward by the injection source 204 through the nozzle 60 and into the mold cavity. For a particular embodiment of a nonmetallic fastener using fiber reinforced ABS plastic for the fastener head, the control system 220 instructs the heating source 210 to increase the temperature of the heating cylinder 206 to a value of about 475° F. to 500° F.

Referring further to FIG. 9, as shown in block 305, the control system 220 instructs the clamp mechanism 216 to hold the mold 24 between the support members 217 and 218 while the nozzle 60 is forcibly engaged with the mold 24 to inject the ABS plastic material into the cavity 52 in a temperature range of about 475 F. to 500 F.

As shown in block 306 of FIG. 9 the control system instructs the injection source 204 to push the molten plastic into the mold cavity 52 at a pressure of approximately 5,000 psi.

The mold 24 may comprise aluminum which readily transfers heat. Once the molten plastic is injected into the mold cavity 52 it is rapidly cooled. In fact, the mold 24 may be suitably designed to provide for water cooling of the mold so that the head of the fastener being formed rapidly solidifies around the shank 20. Once the fastener 10 has been formed (or the fastener 70, as the case may be) the mold 24 or 84 is unclamped and the finished bolt 10 or 70 is removed from the mold, as indicated in block 312 of FIG. 9.

Preferred embodiments of a nonmetallic fastener, molds for forming same and a process for forming such fastener or fasteners have been described in detail herein. Those skilled in the art will appreciate that various substitutions and modifications may be made to the embodiments of the invention without departing from the scope and spirit of the appended claims.

What is claimed is:

1. A nonmetallic threaded fastener comprising:
a continuous externally threaded shank formed of a reinforced plastic; and
a plastic head molded over and integrally joined to one end of said shank.

2. The fastener set forth in claim 1 wherein:
said shank is formed of glass fiber reinforced plastic.

3. The fastener set forth in claim 1 wherein:
said head is molded from one of ABS plastic, Nylon 6/6 and polypropylene.

4. The fastener set forth in claim 1 wherein:
said head includes a hexagon shaped part and a generally hemispherical shaped part integrally joined with said hexagon shaped part and forming a head of substantially constant cross-sectional thickness.

5. The fastener set forth in claim 1 wherein:
said head is formed of a manually graspable knob shape having a rim, a hub integrally joined to said shank and plural circumferentially spaced spokes interconnecting said rim with said hub.

6. The fastener set forth in claim 1 wherein:
said fastener is formed in a mold including a first mold part supporting said shank, a second mold part forming a cavity to be filled with molded plastic to form said head and a third mold part supporting said first mold part and operable to be releasably connected to said second mold part during molding of said head.

7. The fastener set forth in claim 6 wherein:
said third mold part includes a bore for receiving said first mold part releasably supported in said bore and said second mold part includes an injection port for injecting molten plastic into said cavity to form said head when said mold parts are joined to each other.

8. The fastener set forth in claim 7 wherein:
said first mold part is threadedly connected to said shank and said third mold part includes an elongated bore for receiving a portion of said shank when said first mold part and said third mold part are joined together.

9. A nonmetallic threaded fastener comprising:
a continuous externally threaded shank formed of a glass fiber reinforced plastic and a plastic head formed from one of ABS plastic, Nylon 6/6 and polypropylene molded over and integrally joined to one end of said shank in a mold including a first mold part supporting said shank, a second mold part forming a cavity to be filled with molded plastic to form said head and a third mold part supporting said first mold part and operable to be releasably connected to said second mold part during molding of said head.

10. The fastener set forth in claim 9 wherein:
said head includes a hexagon shaped part and a generally hemispherical shaped part integrally joined with said hexagon shaped part and forming a head of substantially constant thickness.

11. The fastener set forth in claim 9 wherein:
said head is formed of a manually graspable knob shape having a rim, a hub integrally joined to said shank and plural circumferentially spaced spokes interconnecting said rim with said hub, said rim, said hub and said spokes being of substantially constant thickness.

12. The fastener set forth in claim 9 wherein:
said third mold part includes a bore for receiving said first mold part releasably supported in said bore and said second mold part includes an injection port for injecting molten plastic into said cavity to form said head when said mold parts are joined to each other.

13. The fastener set forth in claim 12 wherein:
said first mold part is threadedly connected to said shank and said third mold part includes an elongated bore for receiving a portion of said shank when said first mold part and said third mold part are joined together.
